(19) United States
(12) Patent Application Publication
(10) Pub. No.: US 2014/0244765 A1
(43) Pub. Date: Aug. 28, 2014

(54) System and method for messaging and notification.

(71) Applicants: Stanley Benjamin Smith, Fort Mill, SC (US); Lyndon John Smith, Asheville, NC (US); Joseph Tate, Durham, NC (US)

(72) Inventors: Stanley Benjamin Smith, Fort Mill, SC (US); Lyndon John Smith, Asheville, NC (US); Joseph Tate, Durham, NC (US)

(73) Assignee: Stanley Benjamin Smith, Fort Mill, SC (US)

(21) Appl. No.: 13/781,035

(22) Filed: Feb. 28, 2013

(51) Int. Cl. H04L 12/58

(52) U.S. Cl. CPC H04L 51/04
USPC 709/206

(57) ABSTRACT

A system and method to distribute messages and notifications through networked devices and sensors in a pervasive computing environment. Included are a triggering mechanism, affirmation of ownership of message content or associated data, and data or message pricing and payment methods. The method enables smart phones, tablets, sensors, or other devices to structure message processing in accordance with the type of messaging process, the entity involved in the message, the ranges or relationships or hierarchies within the entity, and the urgency of the message itself.

### BACKGROUND OF THE INVENTION

1. Field of the Invention

The invention relates to systems and methods for notification and messaging processes in ubiquitous or pervasive computing environments, including prices and fee exchanges for content within or associated with messages and notifications, attribution of ownership of data associated with messaging and notification, relationships between servers and users and connected or linked devices or sensors, and a system and method to enable users to organize, scale, route, format, set messaging type(s), and prioritize messages and notifications according to hierarchies of urgency or immediacy, range, or type of entity.

2. Description of the Related Art

Email and other methods for messaging and notification are well established in the marketplace. Use of messaging and notification for personal or business purposes through the emerging and expanding ubiquitous or pervasive computing environment is transitioning to include NFC capable devices and sensor generated data and information from or through wireless and radio communications into electronic devices. These multiple and various connected sources of information can now be folded into email, SMS, voice messaging, and other messaging and notification processes.

Art for emailing and message and notification formatting and user interaction through computer interfaces was established in the 1980's and little has been done to address user interaction systemically since then. The typical email program will present the user a screen with a series of spaces for posting in the name of the recipient, the names of those to receive copies, the subject matter of the email, and then a text box to accept the body of the message. If the user needs to indicate urgency, the user goes to a menu bar and adds these additional processing instructions prior to pressing the “send” button. Further, if the user needs to indicate a hierarchical ordering of range or relationships for routing the message, he has to select from flat lists of contacts and post these into the “copy to” field for the email. This standardized sequence for email messaging does not integrate well into messages and notifications from sensors and NFC devices, because the notifications are specific to the operation of those devices and email text for the messages is machine generated or preconfigured. These devices also are typically focused on the timeliness of information, not on the text of a message itself. They are, in effect “urgency” driven.

Current messaging and notification processes are also not well adapted to the automated messaging systems used by IT administrators to track uptime or downtime or other events on their servers or within the systems they are managing, since many of these are also driven by time ranges and triggers and porting of reports, rather than conventional emails. As GPS systems have developed, messaging and notification has been framed around a combination of the location and the hypothesized needs and interests of the person at the location—often for an advertisement. Again, these GPS driven messages and notifications are machine generated or preconfigured. Real time transmission is an advantage for these “call and response” marketing frameworks, however, they are driven from the “top down” or from the marketer to the recipient and not through a reciprocal dialog initiated by the potential customer. Control by the customer of the marketing or advertising message on an ad hoc basis—as enabled by the system and method of the invention described herein, may be a better framework and less intrusive method for long term voluntary user driven collaboration between marketer and customer.

The invention disclosed herein offers a new paradigm for messaging and notification that integrates sensor, NFC, GPS, and traditional email processes. This reconsideration and reconfiguration of the business process itself and the need to accommodate emerging patterns of user behavior for devices such as tablets and smart phones as well as other components of the pervasive computing environment has informed the development of the new art disclosed herein.

Another area of change and transition related to messaging and notifications involves intellectual property rights. Before Google and Facebook and other data aggregating sites and entities were part of the landscape, information transmitted through the internet was between the sender and recipient and was seldom subject to cooptation or hijacking for purposes other than those intended by the person sending the message. The invention disclosed herein enables a sender or user to readily mark notifications and messages as owned property to preclude use of the content in emails and other notification and messaging formats for purposes not intended by the sender. Other features of the invention disclosed herein relate to the ability to escalate and structure hierarchical and extra-organizational routing, which has been common for “IT-centric” notifications and messaging, but not for email, NFC, or sensor data.

Much of the prior art in this arena involves the manner in which servers connect with one another for transmission. A typical recent example of the current state of the evolution of messaging is Anderson (20120317218) involving video messaging by “sending messages with links to video though various messaging platforms. For example, some embodiments include sending electronic messages via email or via an online hosted computer application system for delivery by the online hosted computer application. Examples of the online hosted computer applications include social networking websites such as FACEBOOK®, TWITTER®, and LINKEDIN®. Messages may be generated and sent by a video messaging system directly; through integration of a customer relationship management application with a video messaging system; through an email, text message, social networking message that includes a link to a video message; and other mechanisms.” Another typical example of linking of data and messaging through distributed devices is that described by Polk (U.S. Pat. No. 8,296,477) where “user data is securely transferred from a client device to a mobile device. Data transfer activities at the client are monitored to detect a request to transfer data via a displayed code (e.g., QR code). The data being transferred are verified as being legitimate (e.g., not compromised by malware or otherwise malicious code) before the transfer. Responsive to verifying that the transfer data are legitimate, a code encoding the transfer data is displayed on a display device of the client. A user of the mobile device captures the code using a digital camera or other data scanning device and decodes the code to obtain the transfer data. The mobile device may then perform an action using the transfer data, such as connecting to a website or composing an email to an address included in the transfer data.”

Data transfer included into messaging is expanding. An example of this is Eisenberger (U.S. Pat. No. 8,306,831). Here, “methods, systems and related products for collaborative exchange of healthcare data using a computer network are configured to: (a) receive a participating Subscriber's request for publication of selected clinical data from participating Publishers that have respective Publisher repositories of clinical data; (b) determine whether respective Publishers approve publication of their clinical data for the selected clinical data and the requesting Subscriber; and (c) electronically forward the selected clinical data from those participating Publishers that approve publication of the requested selected clinical data to the requesting Subscriber.”

A series of inventions by the inventor of the invention described herein also involve data transfer and exchange systems and methods. The extensive quotation that follows is drawn directly from the background description for Smith's yet to be published application (Ser. No. 13/567,084) that was developed to explain the evolution of art for systems and methods to expand the data supply chain. “The capacity to implement the data supply chain and provide incentives and compensation for entities participating in data supply . . . has been evolving steadily since Smith introduced the term in his utility patent (U.S. Pat. No. 7,860,760) . . . (This leverages) the advantages of the data supply chain with triggered real time notifications introduced by Smith (U.S. Pat. No. 7,860,760). That invention, Smith (U.S. Pat. No. 7,860,760), enables pricing of notifications and server actions triggered by new or updated data streamed or posted into a data supply chain. Art introduced by Smith (Ser. No. 12/930,280) further enables pricing of data items for inclusion into a data supply chain through a sequence of discovery of the data item through an internet search and then calculation of its popularity or value as a search term. Smith (Ser. No. 12/932,798) also teaches art to weight and price contributions from variably weighted sources and variably weighted observations of research targets or data items. Additional art introduced by Smith (Ser. No. 12/932,797) describes a system and method for calculating fees for a participant in a data supply chain interacting with a graphical user interface (GUI) on a website or host server housing a dataset or a plurality of datasets accessible through said GUI. Further art introduced by Smith (Ser. No. 13/134,596) offers a system and method to facilitate and price data exchange through electronic devices linked to the systems and methods of Smith (U.S. Pat. No. 7,860,760, Ser. Nos. 12/932,797, and 12/932,798). Art has also been described by Smith (Ser. No. 13/200,073) to integrate fees and rewards for incremental improvements, updates, and additions of data itself into data transmission and accumulation processes within Social Networks or networks of users and servers or websites. Smith (Ser. No. 13/136,421) further introduces a system and method for pricing insertion or linking of message streams, RFID tags, UPC codes, and other data strings (such as biometric or gene sequences) to data sources. That invention, Smith (Ser. No. 13/136,421), deals with pricing the uploading of data and data streams through electronic devices . . . Claims of Smith (U.S. Pat. No. 8,271,346) . . . introduce art to cover the enrollment of participants and pricing for participation of enrollees in a data supply chain . . . . Recent art introduced by Smith (Ser. No. 13,545,891) describes a system for enabling pricing and fees for incremental improvement of research questions and research protocols or forms for participants in a data supply chain as they inform and implement real time adjustments to research processes. USPTO class 705 and art group 3625 house much of the antecedent and collateral art for the invention described herein, though other classes and groups also apply.

As art evolves for messaging and notification in pervasive computing environments, methods to include sensors and other devices are evolving. Sandleman (20020097150) addresses data captured from a system for routing messages via a sensor in communication with a central computer server and the sensor detecting a pre-determined condition and forwarding a notification, but the art is tied so specifically to sensor data that it is can only be considered as indirectly connected to messaging and notification as business systems and methods. Rankin and Claiborne (20110289161) have developed art for an “intelligent inbox” to include “generation and application of email allocation rules and/or sub-rules; analysis, parsing, intelligent filing and/or sub-filing, and/or other processing of email content, attachments, and/or other associated data; generation of message and/or message data analytics, statistics, summaries” but the art does not correlate with the organizational framework for the invention described herein, nor with pricing or ownership attribution. Rather the focus is on organizing content associated with emails, not the formatting or transmission of them. Landry (20070100834) addresses methods to manage, share, and access data from distributed networks having occasionally connected devices, including linking and synchronizing data, but the only area of overlap is abstraction of data elements; though even in this case, the approach used differs considerably from the abstraction of data disclosed in the art of the invention described herein.

One relevant introduction of art to deal with emergency messaging is by Jacobs and Ross (20120252398). They propose: “a plurality of devices, such as mobile communications devices, that are out of range of a communications network can communicate via direct communication, such as device-to-device communication, to corroborate characteristics that are indicative of an occurrence of an emergency event. Information related to the occurrence may be corroborated amongst the plurality of devices. A transmitting device, which may be one of the plurality of devices that corroborates characteristics or corroborates information, may generate and transmit the report message comprising the corroborated information. A receiving device may provide the message over a communications network, or the report message may continue to be handed off between devices capable of direct communication, the message eventually reaching a device that is within range of the communications network.” The corroboration of information is effectively a trigger, and the use of a pervasive network for distribution of messages is analogous to the use of a pervasive computing environment of the invention described herein. Variance in the approach is evident in the prior structuring or organizing of the messaging process. Other variances will be evident to those who are skilled in the art, especially the discovery and handoff of messages to devices. Drennan (U.S. Pat. No. 8,275,359) offers art for a “location data determination algorithm” to “determine a frequency at which . . . a . . . device interacts with network elements to determine its location. The location data is stored in a notification server and used to identify a user at a specific location. When a governmental or commercial entity wishes to issue a notification, a message is provided to those users whose location is identified as being in an area defined by the entity. There is no overlap with the art disclosed herein, but a potential synergy is implied as is the case with the art introduced by Velusamy (20110151829) that comes at the problem from a GPS angle. While there is no overlap with the invention described herein, there is a potential synergy in a combination of “alerting registered devices of an emergency call, detecting an emergency call from a calling device; determining an identifier of the calling device; retrieving a list of one or more registered devices based on the identifier; determining location information of the calling device; and generating a notification message for transmission to the one or more registered devices, wherein the notification message specifies notification of the emergency call and the location information of the calling device” with the emailing process of the art disclosed herein.

Horvitz, et al. (U.S. Pat. No. 8,271,631) illustrates the conventional approaches that have been taken to issues addressed by the art of the invention described herein. They present a “system for optimizing the value of communications between communicating parties . . . , a communication group manager that facilitates specifying policies, preferences and/or automated analysis of ideal communication channels, routing and/or scheduling in terms of communicating party groups that can be pre-populated clusters of communicating parties, assembled based on relationships (e.g., organizational), and/or assembled based on satisfying inclusion criteria (e.g., age, location, competence, communication history, meeting history). The communication group manager maps communicating parties into predefined and/or dynamically created groups that facilitate specifying and/or automatically computing ideal communication actions like selecting a channel, displaying lists of potential channels sorted by communicating party preferences, and (re)scheduling communications to different channels and/or times. Ideal communication actions can be identified by maximizing a measure of expected communication utility, where groups provide simplifying abstractions to facilitate assessment of outcome utilities. The method can employ representations of preferences of the contactor and contactee that allow for group-specific preference considerations that weight differentially contactor and/or contactee preference considerations in communication action optimization. The system includes a group wise communication coordinator that identifies optimal group communication sets. The method facilitates a recipient communicating with a group member where the communication utility is optimized based on a preference, and a context associated with the group to which the member belongs”. The long quotation is intended to illustrate that there is an awareness of the need for systems and methods for art that leverages hitherto unconnected and unlinked aspects of messaging and notification. In the art offered by Horvitz, a feature of the invention disclosed herein is articulated; that of determining the circulation parameters for a message, but it is decoupled from user selection and from an urgency level and from an option for selection of alternative or serialized or multiple entities and from a claim of ownership and so forth. Horvitz, in earlier patents (U.S. Pat. Nos. 7,613,722, 7,613,721, 7,613,702) offers variants of a “schema-based notification platform that provides regularized notification handling including user control and normalization of the operation of policies across different information types and contexts. Information-service schemas and services are combined to build a content-sensitive and context-sensitive information service to communicate information to recipient devices of users that subscribe to those services. An information agent service collects the information, and based on various criteria, determines if, when, and how to send and render the information, and to which subscribing client device or devices. The set of schemas include a notification schema that represents the subscription of a service to an information source and details about that information, and a device schema that represents information about user devices. The information agent service accesses criteria including user preferences and user contextual information, including presence information, location information, and schedule information along with people and groups data and extended-context data. Preferences about subscriptions and information handling policies may be stored and used at notification sources or in more central preference encodings. Access to multiple preferences is maintained, and a user interface is provided that allows users to inspect and control multiple subscriptions in one conceptual place.” The complexity of the schema, absence of consideration for a simple GUI, inherent subscription driven access, and other features illustrate again how art of the invention described herein addresses the problem of messaging and notification in a manner that is both original and useful.

Monks, et al. (U.S. Pat. No. 8,380,160) offers art for a communication system for “collaboration amongst a plurality of communication devices . . . during emergency conditions. Emergency trigger(s) are used to detect an emergency condition. Emergency information is collected and can be shared and appended amongst the communication devices prior to the emergency information being transferred in a redundant manner across a plurality communication systems . . . to a plurality of external devices . . . ” The recognition of a need for communication in emergencies correlates with the capability of a user to signify urgency in the invention disclosed herein. Rather than focusing on devices, the invention disclosed herein focuses on user interaction and selection of emergency or urgency levels.

Earlier efforts by Lee, et al. (U.S. Pat. No. 7,518,506) for “communication with a user device via electronic means, including via e-mail transmitted over the internet” formed a foundation for triggering messaging based on events. Lee also included consideration of attachments to messages. McKee, et al (U.S. Pat. No. 7,890,960) addresses the issue of control for delivery of notifications. His art introduces a system that “brokers and serializes the delivery of notifications from multiple sources.” He also introduces art for “a shared notion of user context . . . for determining the appropriate handling for each of the notifications” including a variant on triggering and other rules. Overlap with the system and method of the invention described herein is only in intent, not in the practice or operation of the system and method.

### BRIEF DESCRIPTION OF THE INVENTION

The invention is a system and method for notifications and messages to be transmitted throughout a pervasive computing environment using multiple messaging types and formats by enabling an administrator to configure the operation and behavior of the system and method such that it includes:
1. Establishing triggering conditions via electronic and computational devices and sensors for automated messages and notifications as well as for user initiated choices and options, including an emergency call or email or electronically generated signal(s) or other message format(s) such as SMS messages, phone or voice transmissions, equipment vibrations, and other messaging and notification methods enabled through electronic devices capable of processing computer readable instructions.
2. Enabling allocation of rights to set trigger conditions for an electronic device or NFC device or an electronic sensor to transmit messages or notifications to designated users linked to entities included into the messaging and notification system through various communication methods, hard wired networked devices, and SaaS or “cloud” sites.
3. Assigning rights and access to down line users to use a simple GUI on a smart phone or tablet or NFC or wireless device to configure and transmit messages or notifications.
   a. Enabling links of devices and servers customary in pervasive computing environments, such as through internet authentication, wireless or radio signals with embedded authentication and access permission instructions and the like.
   b. Enabling a user to post or upload access or authentication rights or routines to servers and devices to include in the notification and messaging process.
   c. Enabling a user to supplement or adjust configurations set up by an administrator for the set or sequence or order of screens or GUI interfaces to be posted upon devices associated with the user for the user to select options or choices for the operation of the messaging and notification system unique to himself.
   d. Enabling designated users to manually set up alternate or further processing of messages or notifications.
   e. Enabling posting of GPS location information into messages if devices equipped with GPS capability are part of the pervasive computing environment for the messaging and notification system and method.
4. Enabling users to select from a group of entities they are membered with or assigned or related to within the notification and messaging system by the administrator.
5. Enabling alternate creation of messaging and notification forms and formats
   a. Enabling machine created messages to be posted into notifications and messages in cases where a device or sensor linked to the messaging and notification system detects attainment of a trigger condition.
   b. Enabling a user to set up sequences or priorities for presentation of forms or formats for messages or notifications for efficient entry or posting.
   c. Enabling users to input or create their own messages and notifications through structured input forms.
6. Enabling users to insert a notice or mark of their claim to the intellectual property contained within or attached to a notification or message.
7. Enabling users to also select a division or range or subset of an entity selected from the group of entities to receive a message or notification.
8. Enabling a set of unique notification chains and distribution lists separate from the user selected range or circle for distribution.
9. Enabling selection of a degree of urgency or importance to associate with the message or notification such that the selection of the level of urgency implements processing and distribution of messages and notifications to parties both inside and outside the circle of distribution and consonant with the entity to which the user is assigned.
10. Enabling an option to set an acknowledgment requirement and tracking process for a message or notification as well enabling up line transmission or escalation of the message or notification if the message is not acknowledged.
11. Enabling a user to upload or link contact lists, default messaging and notification formats, and other information in order for the distribution of messages or notifications to be managed and aligned with entities, subgroups within entities, and parties external to entities included into the messaging and notification structure.
12. Enabling a “call and response” process for offering of terms and fees and for indications of acceptance of approval by both administrator and users.
13. Enabling administrators or users to input, upload, or link authentication, banking, and other account information to enable payment and fee exchanges for the messaging and notification process.
14. Enabling logging and recording and transactions and events involved in the messaging and notification system.
15. Enabling reports of activities and processes and message content and payment transactions to be posted and viewable by those granted rights to reporting and payment records.
16. Enabling triggered events or actions as a result of calculations of formulas performed upon datasets associated with users of the messaging and notification system, such as posting of “messages” or tables or data into messages or notifications, postings to associated datasets, routing or distribution to users included in to the system, and requesting or offering options to confirm or acknowledge receipt of a message or notification.

Those who are skilled in the mathematics and engineering of hierarchical processing using algebraic algorithms will be able to deduce how the computer readable code to implement the system and method of the invention described herein can be constructed and implemented. While the inventors are not attempting to patent these algorithms, it is important to note the original art of the invention described herein telegraphs the configuration and development of computer readable code to address user selections from multiple hierarchies, some of which are nested, some of which are vertical, and some of which are lateral or horizontal.

### BRIEF DESCRIPTION OF THE DRAWINGS

FIG. 1 illustrates the manner in which a user of the system and method would, in some variants of embodiments, configure their participation in the system and method using a smart phone or tablet device linked to the server managing the system and method.

FIG. 2 illustrates three additional screens for a typical embodiment that includes a smart phone or tablet device for the user of the system and method to select the entity, urgency, and range of distribution from the first screen, then to compose or construct the message or notification, and then the third screen for an upline or a vetting user or an acknowledging user to further define the processing and routing of the message.

FIG. 3 illustrates how the host server interacts with the user's device.

FIG. 4 illustrates how the administrative user would configure and organize the rules, roles, functions, and components of the system and method or collect configurations and uploads from a user's device.

### DETAILED DESCRIPTION OF THE INVENTION

Terms used the claims, such as entities, ranges, message types, urgency, format, upline, down-line, escalation, acknowledgment, threshold and trigger, while common English words, may have a meaning unique to the invention described herein.

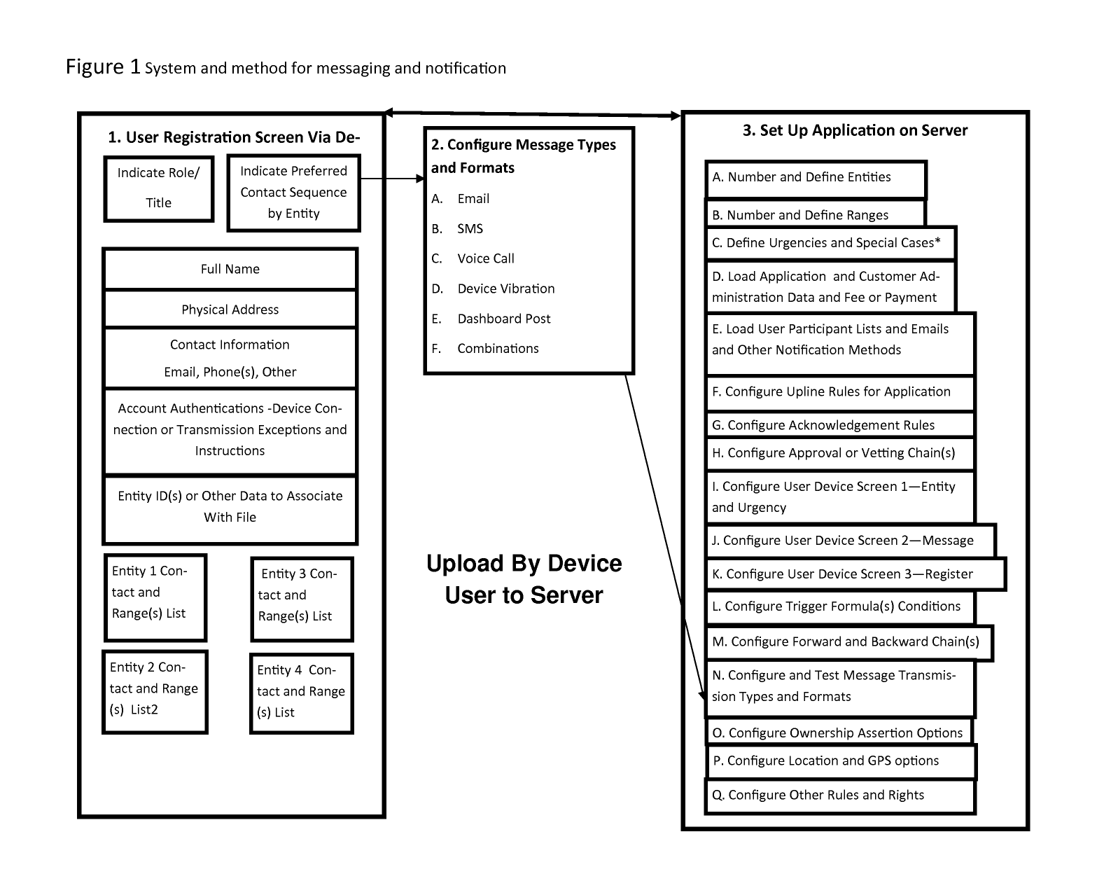

For purposes of clarification, an entity is any unit or grouping that the user of the invention can claim an association with. Examples of entities are “myself” “my employer” “my family” “my friendship network” “my neighborhood” “my church” “my country” and so forth. While FIG. 1 illustrates 4 different entities, it is expected that some users or administrators (or both) within some embodiments would designate only one entity for a user and some might select many entities. There is a natural categorization that probably will hold for many embodiments; from “me”, to “my neighborhood”, to “my employer”, and to my affinity groups such as a “church” or social network. The system and method can accommodate any number of entities that are relevant for the messaging and notification process of the invention described herein. For example, other groupings could be my set of medical providers, my family, my social network membership list, my stock portfolio, my customers, my employees, and so forth.

Entities may or may not contain a range inherent to them. A range is one or more of the units or divisions within an entity, sometimes hierarchically organized and often radiating out in a series of concentric circles. Ranges lend themselves to being organized as a set of concentric circles radiating out from an entity and are expected to be loaded into the system and method of the invention with each additional circle more distant from the pivotal or closest relationship to the entity in question. For businesses or employers, these could be the work team, the functional work unit, the branch, the division, the region, the business unit and so forth. A range could also be organized based on geographic proximity, such the “block”, the “street”, the “neighborhood”, the “township”, the “county” and so forth. It could also be based on biological or social proximity such as nuclear family, first cousins, in-laws, 2nd cousins, and so forth. Some entities may only have a single range, but others may have a quantity of ranges. Again, the system and method of the invention is designed to accommodate as many ranges as are designated per entity. Note in FIG. 1 that the “User Registration Screen” allows the user to load in contact lists and messaging methods for ranges associated with entities.

In FIG. 1, the operations on the Server side and driven by an administrative user are also illustrated. Rules set up on the server side may apply different types of messaging formats and methods for different entities and for different ranges within entities, such as Email, SMS messages, voice phone calls, device vibration, posts into dashboards or onto screens on computers or other electronic devices, and any other messaging or notification method or combination of methods that can be enabled through computer readable instruction. Location information for the sender of the message may be enabled in some embodiments, so the recipient of the message can determine the GPS location of the sending device. This can be particularly important for major emergencies, but can also be helpful for users who want to receive geographically determined notices or messages.

An administrative user may set up alternative message types to use on a per entity basis for some embodiments, though it is expected that most embodiments would link the messaging method and format to the entity and set these up as a sequence or as a grouping depending on non-administrative user preferences. In some cases, the way the messaging and notification process is implemented is dependent on the business practices or needs for messaging or dependent upon whether one form of message has been acknowledged or escalated or is subject to other configurations or processes. In other cases the type of message will result from the values returned by the triggering method inherent in the invention, even if the trigger is automatic due to opening the application or a simple Boolean and not dependent upon calculations or threshold values as is common with most triggers. Re-sending or recission of messages is common in messaging and notification systems and is included in embodiments of the invention described herein.

Urgencies are also variable for the system and method of the invention and operations performed by the server may differ according to the selection of an urgency level. Further, urgencies may operate within the system and method in lieu of triggers or in tandem with triggers. This enables a user with administrative rights to configure actions, events, and sequences for forward or backward chaining of server actions responsive to user or pre-determined selections of choices upon electronic devices associated or linked into the system and method of the invention.

An example of these layers or the hierarchy of urgency and their configurability unique to the concentric circles is as follows. For example, for a neighborhood watch group, selection of the first circle might automate a call or a text to 911 with a message indicating the current location and identity of the owner of the sending device. A second layer of urgency might automate an SMS and an email and a phone call from the device to the local law enforcement agency or designated employees within that agency indicating a need for a community policing assessment or intervention. A selection of the third layer of urgency might send an email only to the set of people designated as reviewers of events within a neighborhood watch group or it may send the message to both the immediate neighbors and the set of watch reviewers. Selection of a fourth circle might notify the 50 homes most closely proximal to the owner of the sending device. In some embodiments, the selection of the degree of urgency would correlate with a specific range, but in other embodiments, the selection of a circle would include notification of multiple ranges. In some instances, such as a neighborhood watch application, the inner circle might be set up to send notifications to the entire set of available ranges inclusive of or exclusive of a 911 call.

The GUI lends itself to an administrator setting up a notification process using entity, range, and urgency as a triad of choices, each in a potential hierarchical relationship internal to the hierarchy and external to the hierarchy. Each may also be in a hierarchical relationship across the triad of entity, urgency, or range, enabling orders of precedence. Each may also have independent exceptions or processing rules per one or a plurality of concentric circles, or have sequencing or embedding rules for alternative configurations, enabling one or a plurality of entities external to the hierarchy to be included or excluded in the messaging or notification process through single or multiple rules.

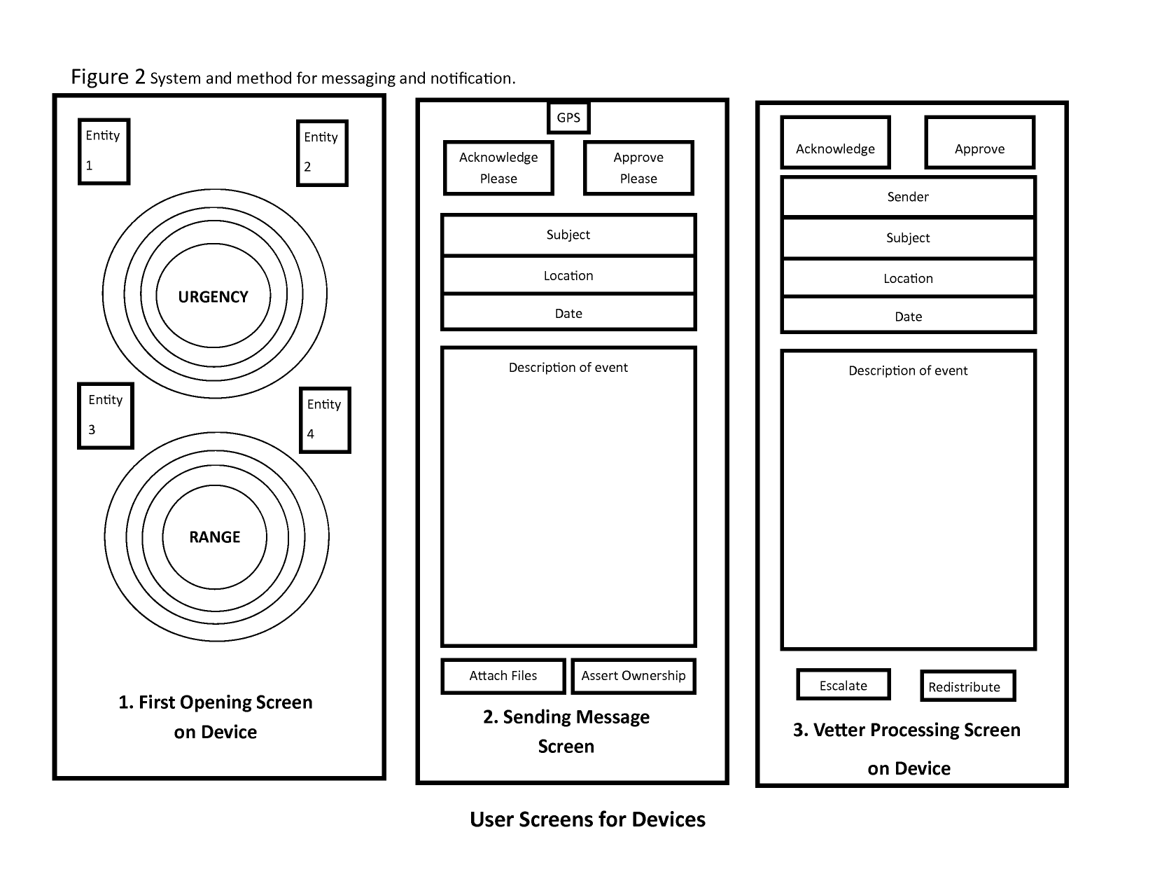

FIG. 2. presents a first screen offering selections by a user opening the messaging application on a smart phone or tablet. The sequence for selection of an urgency or entity or range will vary according to the rules for an embodiment, but the beginning point may, by configuration, be any of the three options of entity, urgency, or range. Once these have been selected, a second screen is presented to the sending user of the device for the sending user to indicate whether they would want an acknowledgement of receipt of their message. Rules may be set up in different embodiments to manage the acknowledgment process. For instance, in a neighborhood watch program, the sending user might want to be assured that the local law enforcement agency has received the message or that their immediate neighbors have received the message.

In some embodiments, the user might want their message vetted or validated for accuracy by an ombudsman for an emergency notification process, (i.e. for a neighborhood watch) or other manager of a process or a cycle of notifications. In that case, they would request approval or vetting on the second screen in FIG. 2. In other embodiments, the sending user might want to indicate ownership of the information within or attached to the message being sent. Their selection of that “button” on FIG. 2 would post in the particulars for their ownership claim and, in some embodiments, include terms for purchase or auction, or trading of the IP associated with the message. FIG. 2 also illustrates the typical email messaging options for inputting text and for attaching files as well as indicating whether GPS or location information should be transmitted with the message if it is enabled through the administration interface. Advantages of sending GPS information voluntarily can be significant in genuine emergencies, but can also be quite helpful if the sending user wants to alert a place of business or service (such as a doctor's office) that they are present in the event they want to receive advertising or forms for completion or other communications and respond via their messaging service to leverage their presence at the venue or location. Such an embodiment would include an entity as a recipient (such as “my shopping venues”) that has a hierarchy or set of variables that will radiate messages by GPS location. An example of the GPS radiation could be from a single shopping aisle, to a single store, to a shopping mall. This feature places the sending user in control of distribution of location information related specifically to the sending user in order for retailers or others that respect user driven access to be assured that the sending user is willing to accept notifications and messages and they are not at risk of intruding upon the rights or preferences of their potential or actual customers.

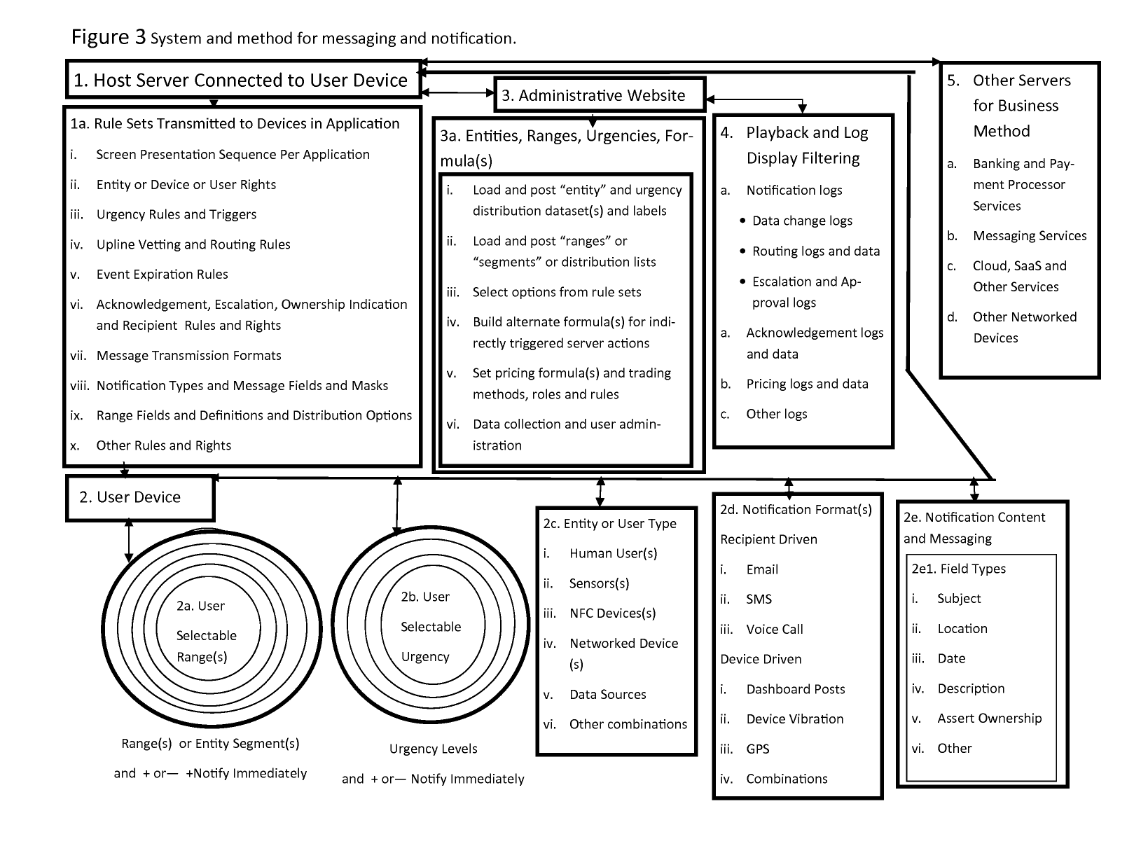

FIG. 3 illustrates the relationship between the user's device and the server. In (1.1a), rules that are transmitted from the server to devices or from devices to the server to be included in the one or a plurality of instances of the application are disclosed. This set of rules is in computer readable code or instructions and includes instructions to both servers and devices included into the system. These rules include those for screen presentation sequences for each application developed using the system and method of the invention described herein. Rules for each entity, device, and user rights for users operating the one or a plurality of devices are also set up and configured and distributed, followed by urgency rules and triggers, upline vetting and routing rules, event expiration rules, rules and rights for acknowledgement by recipients of messages or notifications, escalation of notifications or messages up line if an acknowledgement is not transmitted back to the server by one or a plurality of recipients, rules to indicate ownership of message content or data or of attachments to messages or data, or rules for intellectual property claims by the user sending the message or notification, and other rules and rights associated with either a recipient or sender of a notification or message. These other rights might include whether GPS location information should be included within the message or notification or the number of times a sending user can attempt to send a message or notification, or whether the sending user may pull back a message or reroute it and so forth. Message transmission formats relate to the way messages are constructed to be transmissible from the server to the recipients of the messages as well as the internal formatting rules and requirement for the messages to be accepted into the receiving device or server. This naturally folds into rules for the types of notifications or messages to be sent by the server as well as the fields and masks internal to the messages to enable them to be accepted for posting, logging, and re-transmission. Ranges require labels, and parameters and unique distribution options and rules for constructing or describing these are part of the computer readable code. Other rights and rules are configured and implemented as the unique requirements of the application using the system and method of the invention described herein are determined.

The host server (FIG. 3.1), via (3.1a), feeds the relevant rules for the embodiment of the application to the devices participating in or included into the system and method of the invention described herein to be received and implemented by a user device (FIG. 3.2.) Users may be enabled to modify some of the rule sets, especially the labels or terms to be posted into the GUI upon their devices, but customarily will implement the rules as transmitted, (3.2a) selecting ranges, entity segments or portions, and urgency levels from icons or symbols or other GUI options posted upon their devices after the device portion of the application is loaded or enabled within the device, and invoked or initiated. Types of users or entities involved or included into the system and method may include (3.2.c) human user(s), sensors(s), NFC devices(s), wireless or hard wired networked device(s), SaaS sites that include data sources or provide other software services, or combinations of these that vary according to the variant of the embodiment of the application as enabled.

Notification formats (3.2d) themselves will differ according to whether they are driven by the requirements of the recipients of the notification or by the device implementing the notification. Examples of recipient driven are emails, SMS, and voice messages via a phone. Examples of device driven notifications are dashboard posts, device vibration, and GPS location posting. Combinations of these formats in different embodiments make the process extremely flexible, and will have consequences for national emergencies and public safety notification processes. (3.2e1) explicates some of the field types for notification content and messaging included in one or more embodiments of the invention described herein. Subject, location, date, description, assert ownership, and other fields can be configured according to the embodiment.

Bi-directional communication from the device(s) to the server and from the server to the device(s) is indicated by the lines and arrows within FIG. 3 between FIG. 3.1 and FIG. 3.2. While one server as in FIG. 3.1 may host a website as in FIG. 3.3, alternate embodiments may separate an administrative website from the server. The administrative website 3.3a enables configuration of the entities, ranges, urgencies and formula(s) that shape the operation of the embodiment. Those skilled in the art will readily understand the implications of this separation of major functions and the flexibility derived by enabling the administrative user to load and post “entity” distribution, ranges, urgencies, and build triggers and formulas to operate upon changes to dataset(s) and events or actions performed by users of the system and method of the invention described herein. The administrative user can select options from rule sets to build formula(s) for indirectly triggered server actions, set pricing formula(s) and trading methods unique to an embodiment, set roles and rules unique to an embodiment, and enable data collection and user administration unique to an embodiment.

FIG. 3.4 indicates other functions and actions folded into the system and method. These are customary and will be familiar to those skilled in the art. They include playback and log display filtering, notification logs, data change logs, routing logs and data, and other logging and event tracking. FIG. 3.5 will also be readily understood by those skilled in the art, including links to banking and payment processing services, messaging services, cloud, SaaS and other services as well as other networked devices.

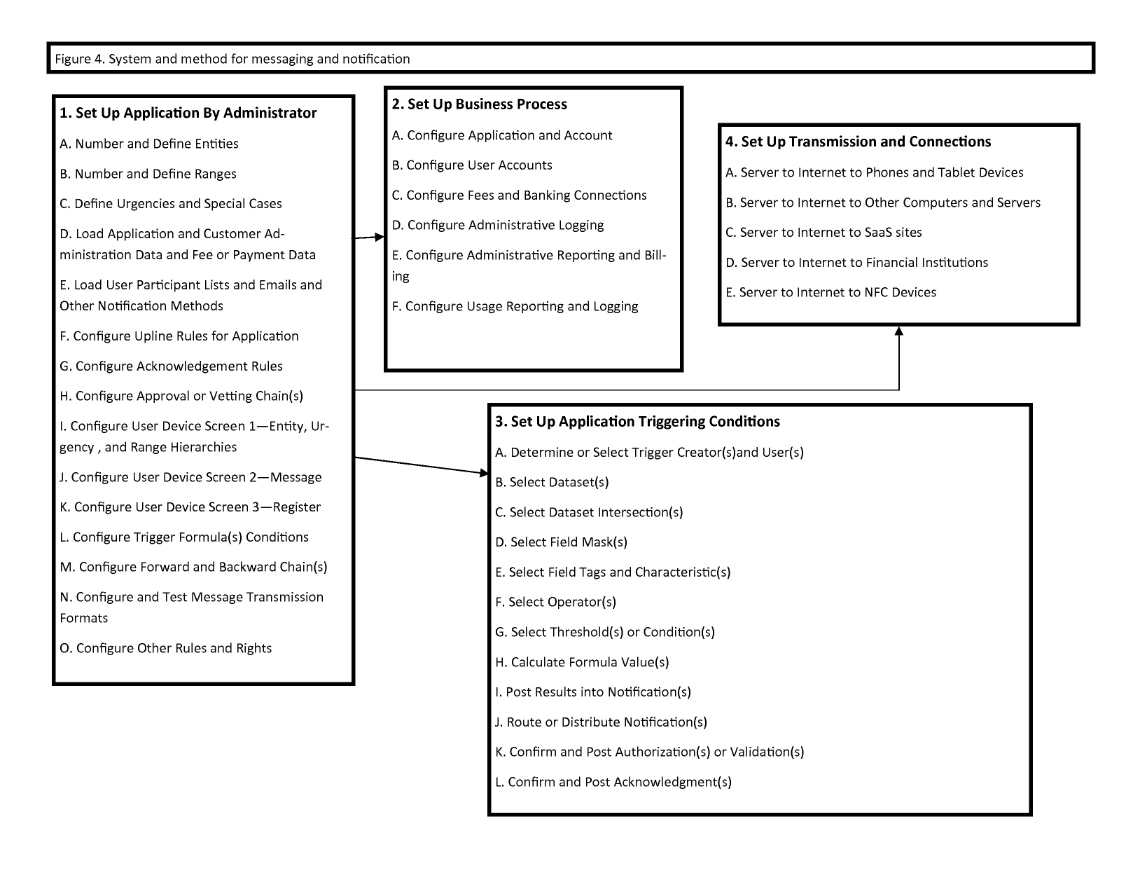

FIG. 4 is focused at the setup process for the system and method driven by an administrator. FIG. 4.1 includes the setup for the embodiment or variant of the application; FIG. 4.2 the business processes included into the application; FIG. 4.3 triggering rules and process for messages within the application; and FIG. 4.4 setup of transmissions across devices and services. Those skilled in the art will readily understand how multiple embodiments can be configured. Following is a more specific map for workflow and administrator and end user actions in a typical embodiment of the invention. It is expected that many variants and alternative embodiments will be generated for the invention, and the detailed sequencing and steps in the following paragraphs are not intended to preclude any of these, but to illustrate that each claim for the invention described herein can be embodied and operationalized.

To further explicate the workflow for an administrator; for each class of entity, the administrator will create user lists by uploading, linking to existing lists, or creating users one by one. Then the administrator will send invitations to log in and configure a user profile and notification preferences and the user can create external recipient lists by uploading, linking to existing lists or by creating them on an ad hoc basis. Next the administrator will build the hierarchy for the entity. For location based entities, users will be assigned to the narrowest range of location and then be grouped into regions (e.g., street, block, neighborhood, ward, bureau, city, county, state, region, country, continent, hemisphere, planet, solar system, sector, quadrant, galaxy, cluster, universe, dimension). Each locale can be recursively grouped into larger regions. Next, the administrator will create supervisory roles for each region and also assign users and external persons to roles within the geographic locales and extend these role assignments outward or upward over each region. For entities that are not driven by location and are also hierarchical (e.g., businesses); the administrator will arrange users into organizational units, and then recursively arrange organizational units into higher level units; and then assign users and external persons to supervisory roles within the organizational units.

For flat organizations (e.g., church groups), the administrator will define the same structure as a business organizational unit, however, since church organizations are typically fixed and since members are frequently members of multiple groups the workflow will streamline creation and reorganization by defining the organizational hierarchy trees. Nodes of the tree will form a set of tags that can be assigned to users and external persons. The administrator then can define leadership roles for each tag (e.g., for Youth Ministry: President, 1st Counselor, Assistant, Teacher, etc.) and distinguish roles that have authority (those that can acknowledge receipt of notifications) from roles without authority (do not have rights to acknowledge receipt of notification). The administrator can import tags and roles, define them from scratch, or copy them from other organizations. The administrator then assigns tags to users (e.g., Youth Ministry, Scouts, Sunday School Class E, Congregant) and assigns external persons to leadership positions according to specific tags.

To set up the scales for scalable factors, such as urgency, range, importance, effect radius, and so forth; the administrator enumerates and defines the scale, then applies scale values to the hierarchy for the entity or organization (e.g., range might map to a locale based grouping, while urgency might map to a leadership structure or both leadership and geographic structures). At this point the administrator defines rules for automatically required actions by second users as in the following examples:
1. Acknowledgments required for level 3, resending the acknowledgment request after 10 minutes, and escalating 1 level after 20 minutes.
2. Acknowledgment requests automatically escalated after 45 seconds for level 4
3. Acknowledgment requests for level 5 are immediately escalated 3 levels, and requests are sent to each of the supervisors of the three levels.
   The next portion of the setup by the administrator is to define default acknowledgment, escalation, and expiration or recission for each supervisory role beginning with naming and defining actions that can be taken upon acknowledgment
1. Acknowledge and Stop. The notification is marked as read/acknowledged, but no further action is taken (a default acknowledgment).
2. Acknowledge and Forward. The notification is marked as read/acknowledged, but then the original notification is forwarded to another hierarchical unit or set of users.
3. Acknowledge and Publish. The notification came from another organizational unit or supervisor. The notification is marked as read/acknowledged, but then sent to every member in the organizational unit.
4. Expire. If the notification requires acknowledgment but the original acknowledger is not responsive, forward it up a level to be acted upon as the original recipient.
   For nodes with multiple supervisory roles, the administrator will:
1. Distinguish authoritative and non-authoritative positions
2. Define the authority hierarchy, and whether acknowledgments can be made by all authoritative roles, just the lead role, or must follow some defined escalation process.
3. Define backup roles (roles that can act with authority when the person with the original role is unavailable or absent for expiration purposes)
4. Define incidental triggers as in FIG. 4.3
5. Define notifications
6. Define non-notification triggered actions as in FIG. 3.5
7. Create non-human input streams as in FIG. 3.2c

The work flow for an end user of the application occurs in the sequence outlined above in lines 607 through 637 and additionally includes the following sequence.
1. Subscribe to notification classes
2. List and configure notification preferences as in FIG. 3.2d and FIG. 3.2e
3. Define personal entities as described in the administrator's workflow for entities
4. Define default copyright for content uploaded or attached
5. Acknowledge and/or review notifications sent to or by the user himself, or pertaining to any personal entities associated with the user, or any organizational units with roles assigned to the user
6. Choose from the set of pre-defined acknowledgment actions
7. Perform another action
8. Configure payment and deposit systems
9. Set up personal profile data
10. Invite other users to join
11. Propose merging duplicate users or external persons uploaded by others

The work flow for the application administrator includes steps 1-11 above and the following activities or functions:
1. Define entities
2. Create new entities
3. Divide one entity into multiple entities
4. Merge two or more entities into one entity
5. Link one entity as an organizational unit of another
6. Delegate an entity administrator role
7. Perform data correction and cleanup routines or delegate rights to perform data-management to another user
8. Configure and view application logs as in FIG. 3.4
9. Approve merges of user lists or external persons if proposed by end users.

1. A system and method for a server to distribute messages and notifications collected from one or a plurality of users of networked devices and sensors in a pervasive computing environment according to a combination of one or a plurality of entities, one or a plurality of ranges, one or a plurality of message types, and one or a plurality of degrees of urgency; and
further enabling one of said one or a plurality of users to act as an administrator of said system and method to configure the operation and behavior of said system and implement rules for assignment of rights and access to one or a plurality of second users; and
further enabling said administrator to set rules for message formats types and transmission alternatives responsive to a user selecting one or a plurality of entities, one or a plurality of degrees of urgency, and one or a plurality of ranges that include subsets of hierarchically ordered contacts within said entity for distribution of messages; and
further enabling said administrator to configure one or a plurality of options for message acknowledgement, one or a plurality of options for message escalation, one or a plurality of options for message re-sending, one or a plurality of options for message recission recall or expiration, one or a plurality of affirmations of ownership of data or text associated with said one or a plurality of messages, one or a plurality of attachments, and one or a plurality of options for message routing to a designated one or a plurality of persons or entities responsive to selections made by a second user if said second user is a human being, and one or a plurality of options for GPS or location information to be included into said one or a plurality of notifications or messages; and
further enabling said administrator to configure one or a plurality of options for message acknowledgement, one or a plurality of options for message escalation, one or a plurality of options for message re-sending, one or a plurality of options for message recission recall or expiration, one or a plurality of affirmations of ownership of data or text associated with said one or a plurality of messages, one or a plurality of options for message routing to a designated one or a plurality of persons or entities responsive to selections made by a second user if said second user is a sensor or device capable of implementing computer readable code; and one or a plurality of options for GPS or location information to be included into said one or a plurality of notifications or messages; and
further enabling said administrator to configure an organizational hierarchy of roles, positions, or relationships for the one or a plurality of entities; and
further enabling said administrator to configure an hierarchy of ranges associated with said one or a plurality of entities; and
further enabling said administrator to set rules for triggered events or actions responsive to threshold values or conditions upon calculation by one or a plurality trigger formulae responsive to data collected and posted into one or a plurality of datasets accessible to one or a plurality of servers included into the system, and upon selection by one or a plurality of second users of a level or degree of urgency associated with said one or a plurality of said second users, a selection by said second user of an entity, and selection by said second user of a range or target for said distribution; and
further enabling said administrator to determine a sequence of screens or GUI's to be posted upon devices of one or a plurality of second users for said second one or a plurality of users to select or indicate one or a plurality of options or choices for operation of said system and method in the processing of messages associated or linked to one or a plurality of entities, one or a plurality of ranges, one or a plurality of message types, and one or a plurality of degrees of urgency associated with said one or a plurality of said second users; and
further enabling said administrator to load in lists of entities including organizational or hierarchical relationships among members of entities; and
further enabling said administrator to load and associate email addresses, phone numbers, device or sensor authentication and linking information to servers and devices associated with one or a plurality of members of said entities, and other contact or demographic information associated with members of said entities; and
further enabling said administrator to identify or allocate rights to one or a plurality of second users who are membered within a designated entity to append, modify, update, or otherwise contribute or load additional or alternate email addresses, phone numbers, device or sensor authentication and linking information associated with said one or a plurality of members, and other contact or demographic information associated with said one or a plurality of members of said entities.

2. The system and method of claim 1, wherein one or a plurality of second users is enabled to upload to said server definitions and parameters for one or a plurality of entities to associate with said second user; and
wherein said one or a plurality of said second users may upload email and other contact lists correlated with ranges associated with said entities selected by said one or a plurality of second users; and
wherein said one or a plurality of said second users is enabled to input or post or insert data into data collection fields within said screens or GUI's for uploading to said server; and
wherein said one or a plurality of said second users is enabled to attach or link data to one or a plurality of messages through selection of one or a plurality of user options presented to said one or a plurality of second users through said screens or GUI's for uploading to said server; and
wherein said one or a plurality of second users is enabled to post or upload access or authentication rights or routines to said server for devices or services associated with said second user; and
wherein said one or a plurality of second users is enabled to input or post one or a plurality of recipient driven or device driven message or notification formats; and
wherein said one or a plurality of second users is enabled to input of post one or a plurality of sequences or priorities for said one or a plurality of recipient driven or device driven message or notification formats; and
wherein said one or a plurality of second users is enabled to input or post alphanumeric data into one or a plurality of fields within one or a plurality of structured or free forms correlated with said one or a plurality of recipient driven or device driven notification formats; and
wherein one or a plurality of second users is enabled to insert affirmation of ownership of said data or text or attachments included in or attached to said one or a plurality of notifications or messages; and
wherein one or a plurality of second users is enabled to insert the current GPS or location information of the sending device into said one or a plurality of notifications or messages.

3. The system and method of claim 1, wherein one or a plurality of second users may instruct and approve said first user connecting to one or a plurality of banking or financial accounts or payment methods associated with said one or a plurality of second users; and
wherein one or a plurality of payment methods, one or a plurality of fees per user or message or notification, and one or a plurality of confirmation and acceptance acknowledgments of payment terms are offered by said first user to one or a plurality of said second users; and
wherein one or a plurality of said second users may approve or verify said payment methods, fees, and terms; and
wherein logs and records of events and transactions are maintained upon the server associated with said first user accessible by said one or a plurality of said second users if authorized by said first user; and
wherein reports of activities and processes and message content and payment transactions are posted for access to said one or a plurality of authorized said second users.

4. The system and method of claim 1 wherein said server may be connected through the Internet and through one or a plurality of wired or wireless networks to one or a plurality of smart phones, one or a plurality of tablet computing devices, one or a plurality of SaaS sites, one or a plurality of financial institutions, and one or a plurality of NFC devices.

5. The method of claim 1, wherein said triggered events or actions result from one or a plurality of second users authorized by said administrator designating one or a plurality of datasets to use for triggering; and
wherein one or a plurality of data fields may be designated for evaluation for one or a plurality of intersections across said one or a plurality of said datasets; and
wherein data connected or linked across or through said one or a plurality of intersections may be designated for inclusion into one or a plurality of formulas containing one or a plurality of operators for calculation of one or a plurality of conditions or one or a plurality of threshold values; and
wherein achievement of a designated condition or value upon calculation by said one or a plurality of formulas may trigger one or a plurality of server actions responsive to attainment of said trigger conditions or thresholds; and
wherein said one or a plurality of said server actions may be one or a plurality of postings into one or a plurality of messages or notifications, postings to one or a plurality of datasets, routing or distribution to designated recipients of said one or a plurality of messages or notifications, and requests or offering of a choice within said one or a plurality of messages or notifications to confirm or acknowledge receipt of said one or a plurality of messages or notifications, designating whether inclusion of GPS location is to be included along with a message, or to enable designated recipients to manually initiate further processing of said messages or notifications.
